(19) United States
(12) Patent Application Publication
(10) Pub. No.: US 2010/0176118 A1
(43) Pub. Date: Jul. 15, 2010

(54) Electric heating film and method of producing the same

(76) Inventors: David Lee, Santa Monica, CA (US); Carl Schalansky, Sacramento, CA (US)

Correspondence Address: MCHALE & SLAVIN, P.A., 2855 PGA BLVD, PALM BEACH GARDENS, FL, 33410, US

(21) Appl. No.: 12/353,582

(22) Filed: Jan. 14, 2009

(51) Int. Cl. H05B 3/34; H05B 3/02

(52) U.S. Cl. 219/549; 29/611

(57) ABSTRACT

An electric heating film comprising of an first polymeric layer having a top surface and bottom surface, a second polymeric layer, a metalized surface, and conductive bus electrodes. The top surface of the first polymeric layer includes a continuous metalized surface of vacuum deposited metal coating and at least one pair of parallel spaced conductive bus electrodes, i.e. copper strips, for connection to a power source. The conductive bus electrodes are conductively adhered to the metalized surface to distribute an electrical current onto the metalized surface to provide a heat across the metalized surface. The second polymeric film sheet layer is provided as a protective layer positioned atop of the top surface of the first polymeric film sheet or enclosing the top and bottom surface of the first polymeric film sheet. The first or the first and the second polymeric layer is mechanical reduced using perforations to reduce the surface area of the metalized surface thereby producing a desired resistance across the metalized surface.

### FIELD OF THE INVENTION

This invention relates generally to an electrical heating film and a method for producing the same. The heating film is formed as a continuous vacuum deposited metal coating having a specified resistance which may be modified by virtue of mechanical reduction. The electric heating film is used to distribute heat onto a surface.

### BACKGROUND OF THE INVENTION

Electric heating films are typically used in applications where space is limited, when a heat output is needed across a surface, where rapid thermal response is desired, or in ultra-clean applications where moisture or other contaminants can migrate. There are various prior art devices which use electric heating film in various applications, for instance the use of electric heating films are disclosed in U.S. Pat. No. 4,990,744 for under-floor heating, U.S. Pat. No. 6,204,480 for window tinting or glazing, U.S. Pat. No. 5,990,449 for mirror deicing or defogging, U.S. Pat. No. 6,686,562 for vehicle heated seating, U.S. Publication No. 2002/0040900 for heating containers, and the like. An electric heating film generally comprises of a dielectric (a non-conducting substance, i.e. an insulator), having a substrate applied thereto, and a resistive material. The substrate is first applied to the dielectric material (discussed in further detail below) and provides an electrical isolation between the substrate and the electrically-live resistive material. The resistive material is applied to the dielectric material in a predetermined pattern and provides a resistive heater circuit. The electric heating film also includes leads that connect the resistive heater circuit to a power source to provide current through the substrate and dielectric material as a source of heat. Accordingly, electric heating films are highly customizable for a variety of heating applications.

Of the many applications where electric heating films may be used, an under-floor heating system is most common. Under-floor heating systems have become more and more prevalent because energy conservation has shifted from an after-thought to an initial design requirement for home designers and builders. Under-floor heating is a form of central heating system that utilizes heat conduction and radiant heat for indoor climate control. Under-floor heating systems are preferred over radiators because under-floor heating systems are not within view, are not noisy, and do not distribute dust from the duct work into the environment. Heat from an under-floor heating system can be provided by circulating heated water or other fluid through tubes or by electric cable, resistance wire, or film. The invisible waves of thermal radiation rise from below the flooring and warm up any object they come in contact with (which radiate that captured heat in turn). A conventional forced-air heating system, in contrast, blows air out of the registers at approximately 120° C. which then rises to the top of the room where it quickly sheds heat and drops back down as it cools. Thus the air in the room becomes uncomfortably stratified. Those jarring ups and downs in room temperature in a conventional forced-air heating system are absent with under-floor heating systems, whereby the warm air rises, but it does so evenly over the entire floor so that the coolest air stays up at the ceiling. In a hot water under-floor systems warm water is circulated through pipes that are laid into the floor (usually a solid concrete subfloor). The disadvantages associated with hot water under-floor systems include downward conductive heat loss to the soil or concrete underneath the piping, insulation and vapor barriers restrictions, expansion of joints in concrete and tiled surfaces, crack formation, floor build up due to the height of the piping, expense to install, noise due to bubbling, frequent maintenance, leakage, and water hammer.

Electric under-floor heating systems using electric cable or film is a preferred alternative. Electric under-floor heating systems are extremely effective as a primary heat source in small spaces because they have low installation costs and are easy to install. Likewise, they are very effective as a supplemental heat source in larger spaces. Known electrical cable or film under-floor heating systems typically vary the spacing of the resistive circuit pattern, as discussed above, such that where the spacing is smaller and the trace of the resistive circuit pattern is closer, the watt density is higher, for a series circuit configuration. For instance, U.S. Pat. No. 4,990,744 discloses an under-floor covering heating system having solid conductor resistance heating wires in a serpentine manner for heating the substrate. Conversely, the larger the spacing between the traces of the resistive circuit pattern, the lower the watt density in those regions. In other known electrical heaters, as disclosed in U.S. Publication No. 2007/0023419, the width of the trace of the resistive circuit pattern is varied along its length in order to vary the watt density, wherein the wider the trace the lower the watt density and the narrower the trace the higher the watt density for a series circuit configuration. However, due to the uneven cable spacing in these resistive circuit patterns, cold and hot spots are common. Furthermore, many electric under-floor heating systems use carbon film (as a substrate). For instance, U.S. Publication No. 2002/0040900 discloses the use of carbon film which is either printed directly on a dielectric film or carried within a cloth layer that is attached to the dielectric film. The drawbacks associated with the carbon film include unpredictable wattage output. As carbon is a semiconductor its physical properties vary widely at temperatures above 50° C.

In addition to the selection of a suitable substrate to be applied to the dielectric material there are drawbacks regarding the application of the substrate to the dielectric material. Electric heating films typically use a “thick”, “thin”, or “thermally sprayed” method of applying a substrate to a dielectric material. Of primary concern are the heating films for “thin” heaters, which are typically formed using a deposition processes such as ion plating disclosed in U.S. Pat. No. 4,707,586, sputtering (vacuum deposition) disclosed in U.S. Pat. No. 4,952,783, chemical vapor deposition disclosed in U.S. Pat. No. 5,780,820, arc plasma spraying disclosed in U.S. Publication No. 2001/0003336, among others. Unfortunately, using these techniques yields a resistance which is not very accurate and requires use of propriety methods during the deposition process in order to reduce the variation of resistance across the electric heating film, specifically with a vacuum deposition process. For example, resistance across a vacuum deposited metal on a dielectric layer has a significant variance. Controlling desired resistance across the electric heating film can greatly improve to provide more accurate and efficient resistance but requires the use of expensive proprietary methods such as controlling the time of exposure of the film to the vacuum deposition source, controlling the power that is used to heat source, controlling the pressure level in the chamber, and controlling the distance from the source to the film have been implemented. Unfortunately, these techniques are extremely expensive and time-consuming.

While these prior art devices may be suitable for the particular purpose to which they address, these prior art devices would not be suitable for the purposes of the present invention as heretofore described. What is needed is an electric heating film and method of producing the same using a continuous coating of vacuum deposited metal on a dielectric film base and obtaining a desired resistance across the electric heating film using mechanical reduction.

### SUMMARY OF THE INVENTION

An electric heating film and a method of producing the same that includes an electrically insulative and thermally conductive first polymeric film layer having a top surface and bottom surface, an electrically insulative and thermally conductive second polymeric protective film layer, a metalized surface, and conductive bus electrodes. The top surface of the first polymeric film layer includes a continuous vacuum deposited metal coating layer and a pair of conductive bus electrodes, e.g. copper strips, which includes leads that extend from the first polymeric film layer for connection to a power source. The conductive bus electrodes are conductively adhered to the metalized surface to distribute an electrical current into the vacuum deposited metalized layer and provide a heating element across the vacuum deposited metalized layer. The second polymeric protective film layer is provided as a protective layer atop of the top surface of the first polymeric film layer forming an electric heating film. It is contemplated that more than one second polymeric protective film layers may enclose the top and bottom surface of the first polymeric film layer to form an electric heating film.

The electric heating film is then mechanically reduced to vary the electrical resistance across the electric heating film. The mechanical reduction includes providing a plurality of perforations across the second polymeric protective film layer, thereby decreasing the surface area of the metalized surface and thus obtaining a specified resistance across the metalized surface.

Accordingly, it is an objective of the present invention to provide an electric heating film and a method of producing the same using continuous coating of vacuum deposited metal on the first polymeric film layer and using mechanical reduction, i.e. perforation, across the electric heating film to obtain a desired resistance.

It is a further objective of the present invention to provide an electric heating film and a method of producing the same capable of providing a heating element in interior space, such as ceiling, flooring, and wall panels. The electric heating film may be used as a primary or supplemental heating means within the interior space.

It is a further objective of the present invention to provide an electric heating film and a method of producing the same capable of a heating solution in exterior surfaces, such as driveways, pathways, and sidewalks. The electrical heating film is particularly useful in continuously removing snow from the exterior surface so ice does not form. The heating solution does not allow ice to form on the exterior surface eliminating the need to use a shovel, snow blower, or chemical treatment. Furthermore, by not allowing ice to form on the exterior surface the electric heating film provides a safer walk way.

It is a further objective of the present invention to provide an electric heating film and a method of producing the same capable of reducing heat loss, specifically, helpful in inflated military tent structures.

It is an additional objective of the present invention to provide an electric heating film and a method of producing the same using a mechanical reduction to precisely control electrical resistance across the heating element by perforating the second polymeric layer, which encloses the first polymeric layer having a vacuum deposited metal coating and copper strips to distribute current to the vacuum deposited metal. Perforations may be formed by a punch or roll method to reduce the amount of surface area of the vacuum deposited metal coating on the electric heating film.

It is an additional objective of the present invention to provide an electric heating film and a method of producing the same to be used as an under-floor heating device for indoor climate control. The electric heating film would have a precision power rating (watts/square foot) due to mechanical reduction.

It is also an objective of the present invention to provide an electric heating film and a method of producing the same with continuous heating over an entire surface eliminating hot and cold spots ever-present in other under-floor heating systems.

It is also an objective of the present invention to provide an electric heating film and a method of producing the same having a metalized surface on a dielectric layer, whereby the metalized surface is a continuous, non-interrupted, non-pattern, and non masking vacuum deposited metal coat. The continuous vacuum deposited metal coat greatly simplifies the production process, makes the production process more reliable, and eliminates the expensive masking process.

It is a further additional objective of the present invention to provide an electric heating film and a method of producing the same that is safe, reliable, cost effective to produce, easy to install, flexible, and maintenance free. Furthermore, the electric heating film and a method of producing the same can be produced easily and efficiently in large numbers.

It is a further additional objective of the present invention to provide an electric heating film and a method of producing the same contemplated for alternative uses such as heated towel rack, heated wall and ceiling panels, moisture remover for damp areas such as closets or the like, heated vehicle seats, compact clothes dryers, agricultural seed growth accelerator, heated clothing, industrial drum heater, and heater for air systems to eliminate noise and pollution.

It is also a further objective of the present invention to provide an electric heating film and a method of producing the same having perforations on the metallic surface thereby allowing the film to be more readily anchored to thin-set tile grout.

It is also a further objective of the present invention to provide an electric heating film and a method of producing the same which may be attached to the underside of a ceiling joist to provide uniform warmth from the evenly heated ceiling surface.

It is yet further an objective of the present invention to provide an electric heating film and a method of producing the same attachable behind a mirror to automatically defog the mirror.

It is yet further an objective of the present invention to provide an electric heating film and a method of producing the same which offers a distribution of heat about a drum to prevent the contents thereof from freezing or to maintain at operating temperatures.

It is yet also a further objective of the present invention to provide an electric heating film and a method of producing the same to maintain a suitable environment for ectothermic animals (reptiles), which require them get their body heat from external sources.

It is yet also a further objective of the present invention to provide an electric heating film and a method of producing the same which is a highly effective direct acting radiant heating system capable of replacing traditional convector radiators by providing a primary source of heating, or alternatively a secondary source of heating to warm a cool floor and provide background heat.

It is also a further objective of the present invention to provide an electric heating film and a method of producing the same to be used in the agricultural field to extend growing and germination periods in cold climates.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a cross-sectional view of the electric heating film without mechanical reduction of the present invention;

FIG. 2 is as top view of the electric heating film without mechanical reduction of the present invention;

FIG. 3 is a cross-sectional view of an alternative embodiment of the electric heating film;

FIG. 4 is a top view of the electric heating film of the present invention;

FIG. 5 is a cross-sectional cut-away view of FIG. 4 of the electric heating film of the present invention;

FIG. 6 is a cross-sectional view of an alternative embodiment of the electric heating film of the present invention;

FIG. 7 is a top view of an alternative embodiment of the electric heating film of the present invention;

FIG. 8 is a cross-sectional cut-away view of FIG. 7 of an alternative embodiment of the electric heating film of the present invention.

### DETAILED DESCRIPTION OF THE INVENTION

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

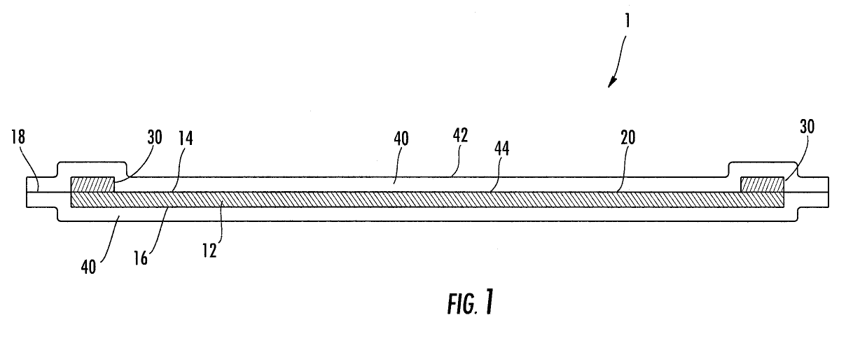

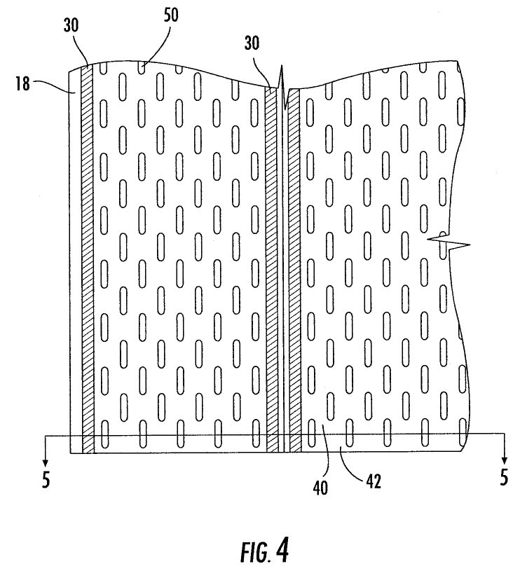

Referring now to FIGS. 1-8, wherein like components are numbered consistently throughout. FIGS. 1-3 illustrate various embodiment of the electric heating film 1 without mechanical reduction and FIGS. 4-8 illustrate various embodiments of the electric heating film with mechanical reduction. The mechanical reduction method, discussed in further detail below, allows for obtainment of a desired resistance across the electric heating film 1 by formation of perforations across the electric heating film. The electric heating film 1 has a first dielectric layer 12 on a planar surface. The first dielectric layer 12 is an electrically insulative and thermally conductive first polymeric film layer that permits electricity to conduct across or therethrough and generates heat when energized. The first dielectric layer 12 is preferably constructed of biaxially-oriented polyethylene terephthlate (boPET) such as commercially available under MYLAR®. Other suitable substitutes for the polymeric film are commercially available under SCOTCHPAR®, and CELANAR®. However, other dielectric material selections, such as plastics, thermoplastics, and the like, are contemplated without departing from the scope of the invention. The boPET is typically available in a variety of thicknesses, which are measured in “mils”. The mil is not a metric unit of measure, however, one mil equals 0.001 inches. It is preferred that the boPET used is 1.5 mils, however, other thicknesses may be used. The first polymeric layer 12 has a top surface 14 and a bottom surface 16, and about the top surface 14 of the first polymeric film 12 are edges 18 extending about the periphery of the first polymeric layer 12. The seal is best made using hot lamination; however, cold lamination such as pressure sensitive will also suffice.

A substrate in the form of a metalized surface 20 is applied to the top surface 14 of the first polymeric layer 12. The metalized surface 20 is deposited onto the top surface 14 using a continuous vacuum metal coating. The metalized surface 20 adheres to the entire top surface 14 of the first polymeric film 12. It is preferred that the edges 18 surrounding the periphery of the first polymeric layer 12 are not subject to the vacuum deposited metal coating. The continuous vacuum deposition manufacturing process is capable of producing thin metalized film surfaces that are very uniform, electrically conductive, and which adhere well to dielectric materials. The vacuum deposition manufacturing process produces a thin metalized film surface 20 having an approximate thickness of 0.0000002 inches or 50 Angstroms. Furthermore, the metal contemplated for use in the vacuum deposition coating is nichrome, nickel, tin and silver, or the equivalent.

A resistive material comprising of a pair of parallel spaced conductive buss electrode bars 30 are conductively adhered to the metalized surface 20. The electrical buss bars 30 are used to allow a powering current to be delivered to the metalized surface 20 to heat the metalized surface 20 for various applications. The electrical buss bars are preferably constructed of copper strips; however, aluminum strips provide a suitable alternative. The electrical buss bars 30 generate a voltage across the metalized surface 20 when energized by a power source coupled to a pair of electrical connectors which may include conductive strips and conductive leads, not shown. It is contemplated that the pair of electrical buss bars 30 need not be spaced parallel to each other. Depending on the application and construction of the electric heating film 1, the pair of electrical buss bars 30 spacing may be positioned ubiquitously about the metalized surface 20.

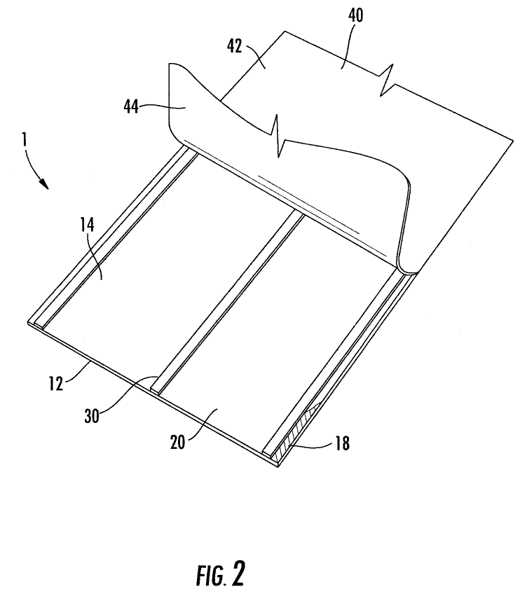

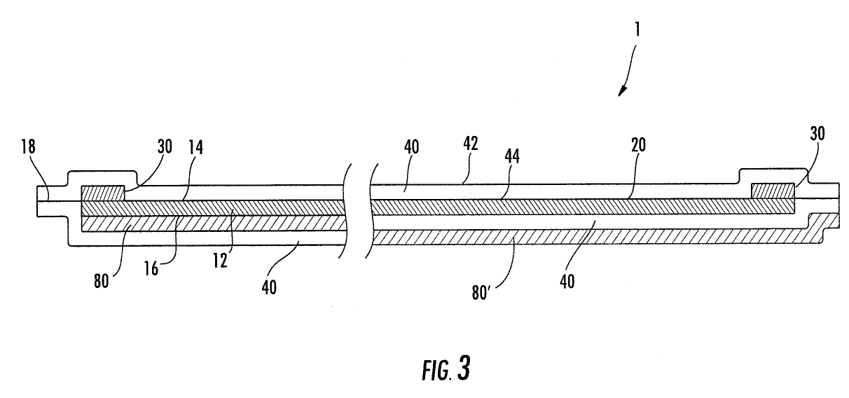

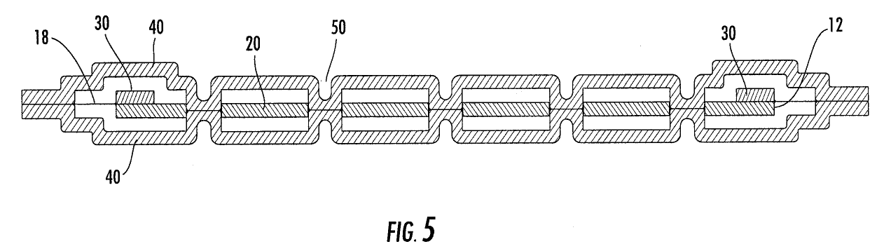

The electric heating film 1 further includes at least one outer protective second dielectric layer 40 having a top surface 42 and a bottom surface 44. The second dielectric layer 40 is an electrically insulative and thermally conductive polymeric layer. The second dielectric layer 40 provides an outer protective layer against scratching, moisture intrusion, etching, and destruction of the metalized surface 20 on the top surface 14 of the first polymeric layer 12. Various embodiments with the second dielectric layer are contemplated and described herein. As shown in FIGS. 1 and 2, the top surface 14 of the first polymeric layer 12 may be enclosed by one second dielectric layer 40. As shown in FIG. 3, a cellular insulating layer 80 may be attached to the first or second dielectric layers 12 and 40, respectively, depending on the electric heating film construction, to help prevent heat from escaping from one side of the electric heating film 1. The cellular insulating layer 80 would incorporate a low thermal conductivity layer and thus forces heat to be removed from the side that is not thermally insulated, greatly increasing the heating effect on the opposite side of the cellular layer 80 of the electric heating film 1. As shown in FIG. 5, the first polymeric layer 12 is positioned between several second dielectric layers 40. As shown, a second layer 40 encloses the bottom surface 16 of the first polymeric layer 12 and another second dielectric layer 40 encloses the top surface 14 of the first polymeric layer 12. Furthermore, additional second dielectric layers 40 may be positioned above a second dielectric layer 40.

The second polymeric layer 40 is preferably constructed of biaxially-oriented polyethylene terephthlate (boPET) such as commercially available under MYLAR®. However, other dielectric material selections, such as plastics, thermoplastics, and the like, are contemplated without departing from the scope of the invention. Due to the polymeric material selection of MYLAR®, the electric heating film 1 is limited to a maximum temperature of approximately 110° C. However, if elastomers, such as silicone rubber or the like, or synthetic fiber, such as commercially available as KEVLAR®, were to be used; then high temperatures for the electric heating film may be achieved in excess of 250° C.

As shown in FIGS. 4-5, one mechanical reduction method for obtaining a desired resistance across the metalized surface 20 includes the formation of perforations 50. The electric heating film 1 before mechanical reduction is deliberately made thick, shown in FIGS. 1 and 2. Then the electric heating film 1 is run through a perforating punch or roll, not shown, that creates multiple perforations 50 to reduce the amount of surface area on the metalized surface 20 and provide a precisely determined power per unit area. Other mechanical reduction methods, which remove portions of the metalized surface to obtain a desired resistance, may be employed without departing from the scope of the invention. There are a number of possible perforation configurations and sizes, each configuration and size selected provides a desired resistance. The perforations 50 are spaced apart equidistant from each other. However, it is contemplated that the distance between the perforations need not be evenly spaced, thus enabling the heating effect to be tailored to any one area. In one embodiment, the perforations are on the top surface of the second polymeric layer and the bottom surface of the first polymeric layer; and in another embodiment, the perforations are on the top and bottom surface of the second polymeric layer, when the second polymeric layer encloses the first polymeric layer. By perforating the electric heating film a variety of resistances may be obtained, until the optimum resistance is achieved for a particular application.

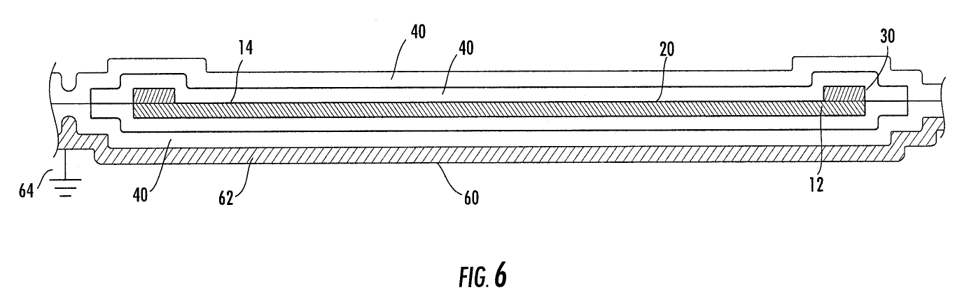

If concerns arise regarding Ground Fault Interruption (GFI) the second dielectric layer 40 may be provided with an additional outer protective layer 60 comprising of a thickly-metalized film which is grounded to meet GFI, as shown in FIG. 6. The additional outer protective layer 60 is constructed of an insulating film, such as boPET, elastomers, or synthetic fiber, as discussed above. The additional outer protective layer 60 has metalized surface 62 of low electrical resistance that is grounded 64 to reduce ground fault electrical currents so GFI circuits are not tripped in various installations. The additional outer protective layer 60 is laminated using the continuous vacuum deposited metal coating process as used on the top surface 14 of the first dielectric layer 12 and discussed above. Furthermore, the additional outer protective layer 60 with a metalized surface 62 can help reduce EMF interference that can interfere with sensitive electronic applications. Alternatively, a metal window screen material being electrically grounded may be positioned between the second polymeric film layer and the metalized surface to drain off GFI currents, not shown.

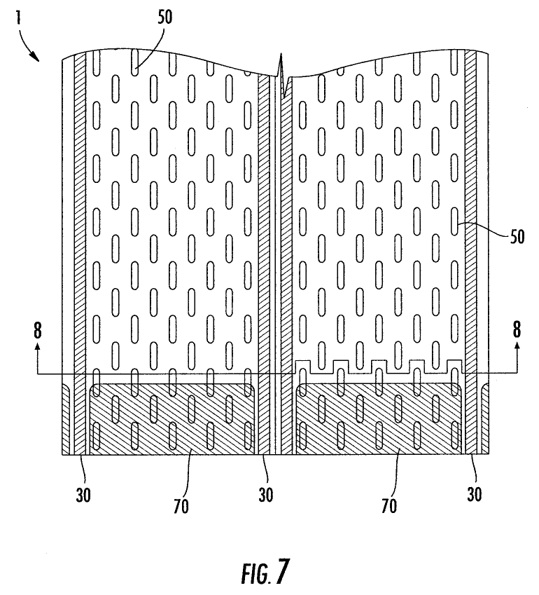

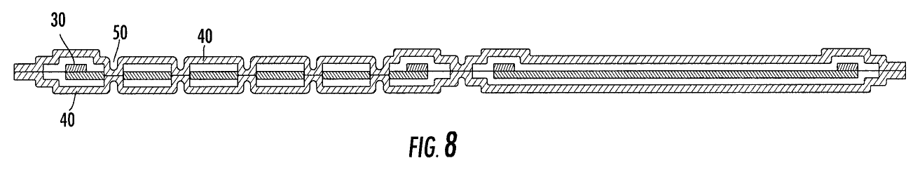

FIGS. 7 and 8 illustrate an alternative embodiment of the electrical heating film for sub-floor installation. The alternative embodiment allows for electrical wiring to be installed flush with the top surface of the second polymeric layer 40 so that flooring may be installed overtop of a planar electrical heating film 1 surface. Conventional subflooring electrical systems require using large insulated round gauge wire. This installation requires grinding a groove in the sub-flooring (usually concrete) to accommodate the wire and create a planar surface for the flooring to be installed overtop. As shown, an area 70, not limited to only the cross hatched area shown, between the electrical buss bars 30 is cut away using any cutting means such as scissors. The cut away area 70 provides a clearance of at least the approximate thickness of the electrical heating film to allow the passage of an electrical wire to pass therethrough. It is contemplated that any exposed edges about the cut away area 70 may be insulated with electrical tape having an adhesive backing.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A flexible electric heating film used to heat a surface comprising of:
a first polymeric layer having a top surface and a bottom surface;
a metalized heating surface deposited on said top surface of said first polymeric layer;
at least one pair of electrical buss bars conductively adhered to said metalized heating surface, said each pair of electrical buss bars, wherein said at least one pair of electrical buss bars distribute electrical current into said metalized surface to provide heat when connected to a power source;
at least one second polymeric layer having a top surface and a bottom surface, said at least one second polymeric layer at least positioned on said top surface of said first polymeric layer to form a seal; and
a plurality of perforations on said first polymeric layer;
wherein said perforations create a desired electrical resistance across said metalized heating surface.

2. The flexible electric heating film used to heat a surface according to claim 1, wherein said first and said at least one second polymeric layer is biaxially-oriented polyethylene terephthalate (boPET).

3. The flexible electric heating film used to heat a surface according to claim 1, wherein said metalized surface is at least one continuous, uniform, vacuum deposited metal layer coating.

4. The flexible electric heating film used to heat a surface according to claim 3, wherein said metal coating is nickel.

5. The flexible electric heating film used to heat a surface according to claim 3, wherein said metal coating is nichrome.

6. The flexible electric heating film used to heat a surface according to claim 3, wherein said metal coating is tin and silver.

7. The flexible electric heating film used to heat a surface according to claim 3, wherein said electrical buss bars are spaced parallel to each other.

8. The flexible electric heating film used to heat a surface according to claim 1, wherein said at least one pair of electrical buss bars are copper strips.

9. The flexible electric heating film used to heat a surface according to claim 1, wherein said at least one pair of electrical buss bars are aluminum strips

10. The flexible electric heating film used to heat a surface according to claim 1, wherein said metalized heating surface has a definite surface area.

11. The flexible electric heating film used to heat a surface according to claim 10, wherein said at least one second polymeric layer is also positioned on said bottom surface of said first polymeric layer to form a seal.

12. The flexible electric heating film used to heat a surface according to claim 11, wherein said plurality of perforations are also included on said second polymeric layer.

13. The flexible electric heating film used to heat a surface according to claim 12, wherein said plurality of perforations varies the electrical resistance across said metalized heating surface by reducing said surface area on said metalized heating surface.

14. The flexible electric heating film used to heat a surface according to claim 13, wherein each said plurality of perforations are positioned an equidistant space apart from each other.

15. The flexible electric heating film used to heat a surface according to claim 13, wherein each said plurality of perforations are variably positioned about said metalized surface.

16. The flexible electric heating film used to heat a surface according to claim 1, wherein said first polymeric layer includes a peripheral edge and said metalized surface is not deposited about said peripheral edge of said first polymeric layer.

17. The flexible electric heating film used to heat a surface according to claim 1, wherein an additional outer protective layer is positioned on said at least one second polymeric layer.

18. The flexible electric heating film used to heat a surface according to claim 17, wherein said additional outer protective layer includes a metalized surface using continuous uniform vacuum deposited metal coating.

19. The flexible electric heating film used to heat a surface according to claim 18, wherein said additional outer protective layer is grounded to reduce ground fault electrical currents.

20. A method of producing an electric heating film for use in heating a surface comprising:
coating a top surface of a first polymeric film layer with continuous, uniform vacuum deposited metal forming a planar metalized surface having a defined surface area;
conductively adhering at least one pair of electrical buss bars to said top surface of said first polymeric film layer,
sealing said metalized surface with at least one second polymeric film layer, said at least one second polymeric layer having a top surface and a bottom surface;
mechanically reducing said surface area on said metalized surface by forming a plurality of perforations on said first polymeric film layer to obtain a desired electrical resistance across said metalized heating surface; and
connecting said at least one pair of electrical buss bars to a power source to distribute electrical current into said metalized surface to provide a heat source.

21. The method of producing an electric heating film according to claim 20, wherein said first and said at least one second polymeric layer is biaxially-oriented polyethylene terephthalate (boPET).

22. The method of producing an electric heating film according to claim 20, wherein said coating of said top surface of said first polymeric film layer includes continuous uniform vacuum deposited nickel.

23. The method of producing an electric heating film according to claim 20, wherein said coating of said top surface of said first polymeric film layer includes continuous uniform vacuum deposited nichrome.

24. The method of producing an electric heating film according to claim 20, wherein said coating of said top surface of said first polymeric film layer includes continuous uniform vacuum deposited tin and silver.

25. The method of producing an electric heating film according to claim 20, wherein said first polymeric film layer includes a peripheral edge and said peripheral edge is not subject to said coating of said top surface of said first polymeric film layer with continuous uniform vacuum deposited metal.

26. The method of producing an electric heating film according to claim 20, including said sealing of said at least one second polymeric film layer to said top surface of first polymeric film layer is about said edges.

27. The method of producing an electric heating film according to claim 20, including forming said plurality of perforation by rolling or punching techniques.

28. The method of producing an electric heating film according to claim 27, including forming said perforations equidistant from each other on said first polymeric layer.

29. The method of producing an electric heating film according to claim 27, including forming said perforations a variable distance from each other on said first polymeric layer.

30. The method of producing an electric heating film according to claim 27, wherein said mechanical reduction of said surface area on said metalized surface formed by said plurality of perforations is also included on said second polymeric film layer to obtain a desired electrical resistance across said metalized heating surface.

31. The method of producing an electric heating film according to claim 30, including forming said perforations equidistant from each other on said second polymeric layer.

32. The method of producing an electric heating film according to claim 30, including forming said perforations a variable distance from each other on said second polymeric layer.

33. The method of producing an electric heating film according to claim 20, wherein said at least one pair of electrical buss bars are formed from copper strips.

34. The method of producing an electric heating film according to claim 20, wherein said at least one pair of electrical buss bars are formed from aluminum strip.

35. The method of producing an electric heating film according to claim 20, wherein said at least one pair of electrical buss bars are spaced parallel to each other.
